(19) United States
(12) Patent Application Publication
(10) Pub. No.: US 2010/0235803 A1
(43) Pub. Date: Sep. 16, 2010

(54) Method and Apparatus for Automatically Connecting Component Interfaces in a Model Description

(76) Inventors: Lara Gramark, Malmo (SE); Magnus Osterholm, Lund (SE); Martin Svenningsson, Malmo (SE)

Correspondence Address: COATS & BENNETT, PLLC, 1400 Crescent Green, Suite 300, Cary, NC, 27518, US

(21) Appl. No.: 12/404,844

(22) Filed: Mar. 16, 2009

(51) Int. Cl. G06F 17/50

(52) U.S. Cl. 716/12; 716/18

(57) ABSTRACT

The Component Interface Definition Language (CIDL) disclosed in this document, along with the associated CIDL compiler, provides advantageous automation and simplification of the process of interconnecting components within modeled systems. In particular, the CIDL compiler automatically determines the correct connections to be made between the components represented within a CIDL source file. These automatic connection capabilities relieve the user from the burden of having to explicate the signal port connections to be made between various ones of the component interfaces represented in the CIDL source code.

### FIELD OF THE INVENTION

The present invention generally relates to modeling systems, such as integrated circuit modules, and particularly relates to automatically generating inter-component connectivity information for modeled components, according to a Component Interface Definition Language (CIDL).

### BACKGROUND

Integration of large and complex hardware systems on a chip is time consuming and error prone, partly due to the number of module ports to be connected through all module hierarchies. To appreciate the number of ports to be connected, consider that current SoC designs routinely include as many as ten million gates.

Designers often generate module port connections at the Register Transfer Level (RTL) by connecting ports/interfaces manually using a Hardware Definition Language (HDL). This process is done by defining “signals” and connecting start/end points through the hierarchy of modules, until the signal paths are complete. Supporting these operations, “standard” HDLs like VHDL and Verilog include provisions for describing binary ports, and SystemVerilog defines interfaces as groups of ports.

Manually-driven design interconnection processes are tedious and prone to error. Large chip designs, and their corresponding test bench designs, are especially vulnerable to data entry errors, given the large amount of connectivity information that must be manually input for them.

As at least a partial alternative, designers connect ports/interfaces manually in a schematic capture tool by entering port/interface names, and relying on the tool's ad hoc string matching capabilities. Connectivity via net name matching is also known, for example, in printed circuit board layout tools, for example. However, in complex, multi-layered designs, the semi-automated connectivity gained through string matching alone is unpredictable, and significant attention from the designer is required to correct and guide such matching tools.

### SUMMARY

The Component Interface Definition Language (CIDL) disclosed in this document, along with the associated CIDL compiler, provide advantageous automation and simplification of the process of interconnecting components within modeled systems. In particular, the CIDL compiler automatically determines the correct connections to be made between the components represented within a CIDL source file. These automatic connection capabilities relieve the user from the burden of having to explicate the signal port connections to be made between various ones of the component interfaces represented in the CIDL source code.

Moreover, the CIDL compiler supports iterative auto-connection processing, which processes the CIDL source code according to a hierarchical set of connection rules and makes all of the unambiguous connections it can make. Connections that are ambiguous within the CIDL compiler's framework of connection rules are flagged, and the CIDL compiler outputs reporting information, e.g., an errors/ambiguities report to guide a user in correcting the CIDL source file, to allow full auto-connection. The CIDL compiler also outputs component interconnection data, representing the automatically completed component interface connections determined by the CIDL compiler. This data is formatted according to the targeted implementation language/simulation environment. For example, the CIDL compiler outputs the component interconnection data as an architectural file for input to a VHDL or Verilog compiler.

One embodiment presented in this document comprises a method of automatically generating component interface connections for components represented in source code defining a hierarchical architecture of components. The method includes processing the source code via a programmed computer system, according to a defined set of connection rules that automatically connect component interfaces included in the hierarchical architecture. The method further includes outputting the resulting component interconnection data as computer-readable electronic data. That data specifies the automatically generated component interface connections, for subsequent modeling of the hierarchical architecture of components in a targeted implementation language/simulation environment.

Automatically connecting component interfaces, as mentioned above, comprises generating connection data identifying which component interfaces are to be interconnected. The rules for automatically connecting component interfaces include a first connection rule that automatically makes one-to-one connections between signal ports included in unambiguous pairings of complementary component interfaces of the same type. Further, a second connection rule automatically makes one-to-many connections between signal ports included in unambiguous groupings of complementary component interfaces of the same type.

One or more embodiments use additional connection rules, which may be applied sequentially, where a succeeding connection rule works to resolve connection ambiguities remaining after application of one or more preceding rules. Further, the connection rules may exhibit further hierarchical functionality, in that one or more of the connection rules traverse the hierarchical architecture, such that component interfaces at different levels of design hierarchy are interconnected to gain complete connectivity. These operations may be subject to any traversal restrictions in place for given components or architectures.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a hierarchical architecture, including components, component interfaces, and signal ports.

FIG. 2 is a block diagram of one embodiment of a computer system, configured to implement a Component Interface Definition Language (CIDL) compiler.

FIG. 3 is a flow diagram illustrating one embodiment of CIDL source code processing by a CIDL compiler.

FIG. 4 is another flow diagram illustrating one embodiment of a CIDL source code processing by a CIDL compiler.

FIG. 5 is a block diagram of an example hierarchical architecture implemented via CIDL.

FIG. 6 is a block diagram of another example hierarchical architecture implemented via CIDL, including design reuse.

FIG. 7 is a block diagram of a leaf component represented in CIDL.

FIG. 8 is a block diagram of an “unrestricted” architecture represented in CIDL.

FIG. 9 is a block diagram of a “restricted” architecture represented in CIDL.

FIG. 10 is a block diagram of a hierarchical architecture represented in CIDL, according to one embodiment of design reuse in CIDL.

FIG. 11 is a block diagram of a hierarchical architecture represented in CIDL, according to another embodiment of design reuse in CIDL.

FIG. 12 is a block diagram of a hierarchical architecture represented in CIDL according to one embodiment of labeling in CIDL.

FIG. 13 is a block diagram of a hierarchical architecture represented in CIDL according to one embodiment of cabling in CIDL.

FIG. 14 is a block diagram of a hierarchical architecture represented in CIDL according to one embodiment of (interface) map components in CIDL.

### DETAILED DESCRIPTION

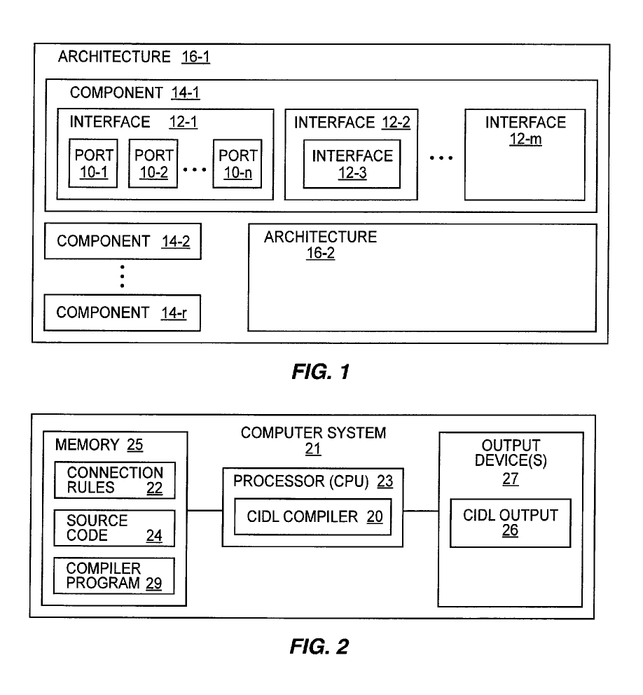

FIG. 1 illustrates a generic example of one embodiment of a hierarchical structure used for implementing a Component Interface Definition Language (CIDL) language. The CIDL language uses the illustrated hierarchical structure to reduce the complexity associated with modeling complex systems, and to aid design reuse. In this regard, the CIDL language does not provide for behavioral/functional simulation, but instead provides for efficient generation of interface connectivity information, as between the various interfaces of the entities to be modeled.

According to the hierarchical model from the lowest to highest order in the hierarchy, the CIDL provides type instantiations for ports 10 (10- 1, 10-2, etc.), interfaces 12 (12-1, 12-2, etc.), components 14 (14-1, 14-2, etc.), and architectures 16 (16-1, 16-2). The overall architecture 16 defined in a given CIDL-based design may be thought of as a system, and the CIDL language provides an efficient basis for defining the various interfaces 12 that interconnect within a given system.

More particularly, the interfaces 12 provide the points of interconnection between entities in a given architecture 16, and the (signal) ports 10 define the particular points of signal connections within a given interface 12. Thus, as a general proposition, an architecture 16 includes one or more components 14, and individual components 14 interface with one or more other components 14 within the architecture 16, according to their defined interfaces 12 and the ports 10 included in those interfaces 12. Note that the CIDL provides for “type” attributes, for instantiating different types of architectures 16, components 14, interfaces 12, ports 10, etc. In at least one embodiment, the CIDL uses inheritance and polymorphism features, such as type reuse, type extension, and type parameterization, to allow existing type information to be used for creating new type information.

The CIDL language also understands and supports “nested” entities. Thus, a given architecture 16 can include entire other architectures 16, which may be thought of as systems within systems. Similarly, interfaces 12 include ports 10 and can include other interfaces 12, including arrays of interfaces 12. While components 14 are considered as “leaf” elements within the architecture—i.e., they do not contain other components 14—CIDL provides for nesting architectures 16 and various other types of hierarchical elements. Thus, for example illustration, the figure depicts architecture 16-2 nested within architecture 16-1, and also shows interface 12-3 nested within interface 12-2, and so on.

As noted, the ability to nest hierarchical elements—i.e., to instantiate a given hierarchical element within another instantiation of the element—provides for easy design reuse. For example, a given system designer generates a CIDL architecture that provides a complete description of a given system in terms of its interfaces, and can then include that whole system in another design, simply by instantiating that architecture in the new design.

More significantly, however, the CIDL and corresponding CIDL compiler proposed in this document allow system designers to work with “connectionless” source code. With connectionless source code, the signal interconnections within a given system are inferred by the CIDL compiler, from the port/interface attributes defined for the system. The ability of the CIDL compiler to logically infer desired signal connections from the CIDL architectural relationships and element attributes in a given CIDL source file greatly simplifies the system definition task, reduces errors, and facilitates design reuse.

In particular, the CIDL compiler implements a set of connection rules, which it uses to infer connection information that is carried implicitly in a CIDL source code file. FIG. 2 depicts an example embodiment, where a CIDL compiler 20 includes a hierarchical set of connection rules 22, which may be embodied in computer program instructions comprising a series of logical evaluations predicated on evaluating entity type and attribute information for entities within a given CIDL architecture 16. Here, “entity” generally refers to a logically represented element (e.g., interface 12, component 14, etc.) within a CIDL source file.

With this arrangement, the CIDL compiler 20 deduces the correct interface interconnections for the architecture 16 represented in the source code 24, based on processing the source code 24 according to the connection rules 22. That processing produces output data 26, which includes the deduced interface connection data. In at least one such embodiment, the CIDL compiler 20 follows a number of particular interface connection rules included in the set of connection rules 22.

In more detail, FIG. 2 depicts a computer system 21 that is configured to automatically generate component interface connections for components 14 represented in the source code 24, which defines a hierarchical architecture 16 of components 14. The computer system 21 includes a processor 23, memory 25, and one or more storage and/or output devices 27. Those skilled in the art will appreciate that the computer system 21 is specially configured or otherwise adapted to carry out the CIDL processing as described in this document. In one or more embodiments, the computer system 21 is specially adapted by virtue of executing stored program instructions 29 via the processor 23. Such execution may constitute a program thread or task within a larger operating system, such as WINDOWS, OS X, UNIX, etc.

It should also be understood that memory 25 may comprise different types of memory or storage devices, including volatile, working memory (DRAM) and non-volatile memory for storage, whether FLASH, hard disc, etc. Likewise, the output device(s) 27 may include file I/O, wherein the CIDL compiler 20 outputs the data 26 as electronic files stored in a computer-readable medium (e.g., hard disc), for use by the compiler user. The computer system 21 also may include a keyboard, one or more monitors, etc., for supporting interaction with the compiler user.

In any case, the computer system includes memory 25 to hold the source code 24 for processing, and includes the processor 23, which is configured to carry out CIDL compiler processing based upon its execution of the stored compiler program 29. In one or more embodiments, the processor 23 is configured to parse the source code 24 according to the defined set of connection rules 22, including a first connection rule that automatically makes one-to-one connections between signal ports 10 included in unambiguous pairings of complementary component interfaces 12 of the same type, and a second connection rule that automatically makes one-to-many connections between signal ports 10 included in unambiguous groupings of complementary component interfaces 12 of the same type.

The processor 23 is further configured to output the data 26 as computer-readable electronic data that specifies the automatically generated component interface connections, for subsequent modeling of the hierarchical architecture 16 of components 14 in a targeted simulation environment. That is, the output data 26 comprises or includes component interconnection data as computer-readable electronic data that specifies the automatically generated component interface connections, for subsequent modeling of the hierarchical architecture of components in a targeted implementation language/simulation environment. As non-limiting examples, the architecture 16 may represent a system of modeled hardware and/or logical processing or signal generation components, to be simulated in an HDL environment, and the processor 23 thus may be configured to output the data 26 as one or more HDL-formatted architectural files, which can be read by a targeted HDL compiler. If so, the architectural file includes the automatically generated component interface connection data.

In at least one embodiment, the processor 23 is configured to parse the source code 24 according to the first and second connection rules by traversing the hierarchical architecture 16, to identify the unambiguous pairings and groupings of complementary component interfaces 12 of the same type, within and across all hierarchical levels of the hierarchical architecture 16, except for component interfaces that are restricted to their corresponding hierarchical levels. A “restricted” architecture in the sense that the connections that can be made to/from it are limited to those provided by a specified component interface. For example, “architecture x implements component y” restricts the interfaces to/from architecture x to those defined by component y. Restriction thus can be used to prevent automatic propagation/connection of interfaces within a given architecture 16, although automatic connection generally is still performed inside the boundaries of a restricted architecture 16.

Further, in at least one embodiment, according to the first connection rule, the processor 23 is configured to connect corresponding signal ports 10 included in any two component interfaces 12 of the same type, if one of the two component interfaces 12 is un-mirrored and the other is mirrored, and if those two component interfaces 12 are the only instances of that interface type within the hierarchical architecture 16. In the same or other embodiments, according to the second connection rule, the processor 23 is configured to connect corresponding signal ports 10 among more than two component interfaces 12 of the same type, if one of the more than two component interfaces 12 is un-mirrored and the others are mirrored, and if the un-mirrored component interface 12 has a multicast attribute set to a value greater than one.

Further, in at least one embodiment, the processor 23 is configured to parse the source code 24 according to a third connection rule, included in the defined set of connection rules 22. According to the third connection rule, the processor 23 is configured to connect corresponding signal ports 10 between two component interfaces 12 of the same type, if one of the two component interfaces 12 is un-mirrored and the other is mirrored, and if the two component interfaces 12 have label attribute values that are the same.

Further, in at least one embodiment, the processor 23 is configured to parse the source code 24 according to a fourth connection rule, included in the defined set of connection rules 22. According to the fourth connection rule, the processor 23 is configured to propagate any given component interface 12 out of its architectural level within the hierarchical architecture 16, for interconnection with another component interface 12 of the same type at another architectural level, if application of the first through third connection rules does not result in connecting the given component interface 12 within its architectural level. Also, according to this connection rule, the given component interface 12 is propagated out of its architectural level if the value of a multicast attribute of the given component interface 12 exceeds the number of found one-to-many connections for the given component interface 12 at its architecture level.

The same or other embodiments are configured to parse the source code 24 according to a first additional connection rule, wherein the processor 23 is configured to make bottom-up hierarchical connections in combination with component interface propagation, wherein signal ports 10 for given component interfaces 12 are propagated out from their given architectural levels, as needed, to obtain complete connectivity for all component interfaces 12 within an overall system hierarchy that is defined by or includes the hierarchical architecture 16.

The same or other embodiments are configured to parse the source code 24 according to a second additional connection rule. According to the rule, the processor 23 is configured to inhibit interface propagation—such as would otherwise be done for the first additional connection rule, as described above—for component interfaces 12 that are restricted within the hierarchical architecture 16.

Additional, or alternatively, the processor 23 is configured to parse the source code 24 according to yet another additional connection rule. According to this additional rule, the processor 23 is configured to inhibit interface propagation for any given component interface 12 that has a terminate attribute set, and is configured to drive signal port lines of component interfaces 12 having set terminate attributes with default or user-configured signal values. A “set” terminate attribute simply means that the attribute parameter for a given component interface 12 is set to some non-zero value, or any predefined value that indicates that “termination” logic should be applied to the given component interface 12. The attribute parameter and other parameters for any given component interface 12 can be set at design time at any hierarchical level.

Further, in the same or other embodiments, the processor 23 is configured to instantiate one or more component interfaces 12 in the hierarchical architecture 16 by extending or reusing a preexisting component interface type. Similarly, in at least one such embodiment, the processor 23 is configured to override one or more component interface attribute values of the preexisting interface type, as part of instantiating the one or more component interfaces. That is, a new component interface 12 can be created using another component interface as a template, but attribute values can be set or overridden as needed for the new component interface 12. Broadly, this configuration supports a method of overriding an attribute value or replacing a type instance of a preexisting interface type, a preexisting component type, or a preexisting architecture type, as part of instantiating a component interface 12, a component 14, or an architecture 16.

Use of any or all of the above connection rules 22 impart to the CIDL compiler 20 the ability to deduce the correct connections to be made between the different component interfaces 12 represented in the source code 24. That is, the logical application of the connection rules 22 results in the identification of component interfaces 12 which should be interconnected, and the CIDL compiler 20 correspondingly “makes” those connections by generating output data specifying the connections to be made in a targeted implementation language/simulation environment. Thus, as one of its advantages, the CIDL compiler 20 is configured to infer, deduce, or otherwise determine interface connections for any given architecture 16 by parsing “connectionless” CIDL source code 24.

Broadly then, this document discloses a method of processing (CIDL) source code 24 according to a hierarchal set of connection rules 22 that include:
a first rule that connects two interface instances of the same type where one of them is un-mirrored and the other is mirrored, if those are the only instances of that interface type (one-to-one connection);
a second rule that connects more than two interface instances of the same type where one of them is un-mirrored and the others are mirrored, if the un-mirrored instances have their “Multicast” attribute set to a value >1 (one-to-many connection);
a third rule that connects two interface instances of the same type where one of them is un-mirrored and the other is mirrored, if they have the same label attribute values (one-to-one or one-to-many connections);
a fourth connection rule that propagates an interface instance out of its architectural level, if application of the above rules does not result in its connection within that level, or if the value of its Multicast attribute value exceeds the number of found one-to-many connections for the interface at this architecture level;
a fifth connection rule that performs bottom-up hierarchical connections combined with interface propagation, to obtain complete connectivity for the overall system hierarchy;
a sixth connection rule that inhibits interface propagation out of a restricted architecture; and
a seventh connection rule that inhibits interface propagation out of an architecture if the interface instance has the “terminate” attribute set.

From the above rules, one sees that the CIDL uses a number of interface attributes that are set to default or user-configured values, and whose values can be redefined when a nested, enclosing architecture 16 is instantiated. Example, interface attributes and associated logical constructs and processing include:
the Mirror attribute, where an un-mirrored interface 12 is the master/requiring side, and a mirrored interface 12 is the slave/providing side—notably, Mirror attributes may be evaluated up and down the architectural hierarchy to reconcile interface connection ambiguities;
the Multicast attribute, which defines one-to-many interface connections;
the Label range type and Label attributes that define deterministic interface connections in case of ambiguity (e.g., by interconnecting ports associated with like Label attribute values); and
the Terminate attribute that specifies whether an interface is to be terminated rather than interconnected;
interface arrays defined by label ranges;
hierarchical interfaces;
nesting features, allowing an instance of a given type to include one or more instances of the same type—e.g., components within components, interfaces within interfaces, etc.;
unrestricted architectures (no restrictions on top-level interface instances);
restricted architectures (implements the interfaces of a component at its top-level);
Attribute redefinition (overriding), where attributes can be programmatically redefined during instantiation, and where attributes can be redefined hierarchically, where higher-level definitions override lower level definitions;
Type instance redefinition (overriding);
the ability to replace/remove/add instances from several levels up in an instance hierarchy, where upper level instance redefinitions override lower level definitions;
type extension (ad-hoc polymorphism);
type reuse, where underlying instance redefinition is used; and
type parameterization (parametric polymorphism).

In at least one embodiment, if an interface 12 of a given type has its “Terminate” attribute set, that interface instance will not be propagated or connected. Instead, it will be terminated and the signals for ports 10 included in the interface 12 will be driven with default or user-defined values. Also, as noted, the particular components 14 included within a given architecture 16 determine which interface type instances are propagated from the architecture 16. As part of exercising this rule, the CIDL compiler 20 generates reporting information. For example, it reports whether there are propagation mismatches or other errors, such as where there are too many or too few interface type instances to be propagated from the architecture, in bottom-up fashion within the top-level architectural hierarchy.

Further, the CIDL compiler 20 looks at the “Mirrored” attribute setting that is included in interface type definitions. If there are either only un-mirrored or mirrored interface type instances for all instantiations of a given type of interface 12 at a given level within the hierarchy, the CIDL compiler 20 traverses the hierarchy, propagating the port/interface connections upwards in the overall hierarchy, until complementary instances are found or the top-level has been reached.

If the top-level in the overall architecture 16 is reached without finding any complementary interface instances, then the interfaces 12 propagated to the top of the hierarchy will be visible in generated output as interfaces/ports, and the CIDL compiler 20 may generate corresponding reporting information. On the other hand, unless there are connection ambiguities, the CIDL compiler 20 connects complementary mirrored/un-mirrored instances of the same interface type within the architectural hierarchy. Interface instances that do not have their “Multicast” attribute set are connected in complementary pairs, in one-to-one fashion. On the other hand, if a given interface type instance has its Multicast attribute set it will be connected to the specified number of complementary instances of the same interface type in a one-to-many connection arrangement.

On the other hand, if there are fewer than the specified number of complementary interface instances to interconnect with, the CIDL compiler 20 interconnects to the available interface instances, and decrements the Multicast attribute value to indicate the actual number of complementary interface instances that were connected. It also may generate corresponding reporting information. Conversely, if there are too many complementary interfaces, the CIDL compiler 20 attempts to resolve the connection ambiguities.

For example, the interface type definitions include a “Label” attribute, used for optionally naming given interface/port connections. The CIDL compiler 20 in one or more embodiments thus uses label names as a basis for reconciling connection ambiguities. In one or more embodiments, the CIDL compiler 20 prioritizes label connections over mirrored/un-mirrored attribute connections. As such, the CIDL compiler 20 first connects like interface instances in different hierarchical levels if they are of the same type and share the same Label attribute value(s), before it connects complementary mirrored/un-mirrored interfaces of the same type on the same hierarchical level.

In another embodiment, the CIDL compiler 20 requires that interfaces 12 be complementary to be connected, even if labels are used. Further, additional attributes may be used to drive interface connection rules, such that non-complementary interfaces 12 of the same type may be connected, or otherwise merged, before propagating them within their containing architectural hierarchy. Such behavior is desirable where it is known that the interface instances at issue will be connected outside of their architecture 16 to complementary interfaces 12 of the same type.

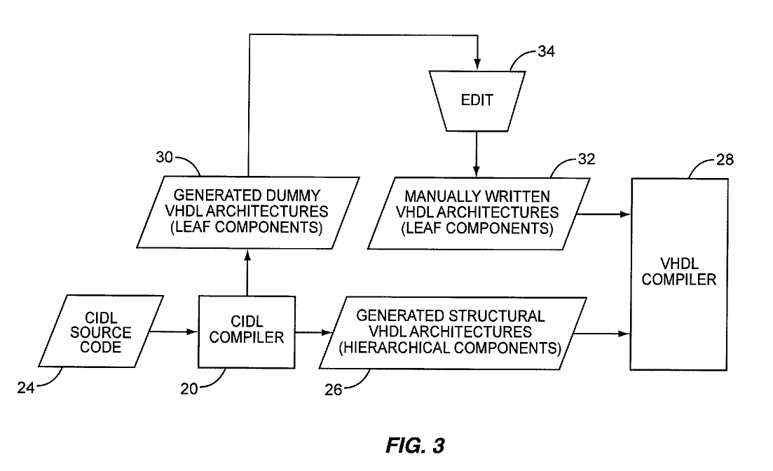

FIG. 3 illustrates example processing associated with the CIDL compiler 20 implementing the above hierarchical set of connection rules, or a desired variation of them. The illustrated CIDL compiler 20 implements a method of processing source code 24 that includes component interface descriptions for components 14 to be modeled in a simulation environment, where the component interface descriptions are constructed in accordance with defined interface types and defined interface attributes according to the CIDL. The method comprises parsing the source code 24 to identify component interfaces 12 of the modeled components 14, as defined by the component interface descriptions. The method further includes identifying the included interfaces 12 by their type information and associated interface attribute settings.

The CIDL compiler 20 automatically deduces intended signal interconnections between the identified component interfaces, by processing the component interface descriptions included in the source code 24 according to the defined set of connection rules 22. The CIDL compiler 20 outputs the determined component interconnection data as output data 26. Assuming a VHDL simulation environment is targeted, the output data 26 includes generated structural VHDL architectures for a VHDL compiler 28. Those skilled in the art will appreciate that the format of the output data 26 differs for different targeted compilers 28. For example, if the compiler 28 is a Verilog compiler, the CIDL compiler 20 would output Verilog-formatted output data 26.

Because the CIDL compiler 20 generates connection information rather than functional modeling information, the CIDL compiler 20 also generates a dummy architectural file 30 that includes dummy or empty architectural definitions corresponding to “leaf” elements represented in the source file 24—e.g., components 12. Leaf elements correspond to functional elements in the design, and the CIDL compiler 20 is configured to generate structural information—architectural connection data—rather than functional behavior information. Thus, the dummy architectural file 30 provides a basis for externally generating the behavioral modeling information needed for actual functional simulation. For example, behavioral simulation information may be integrated into the dummy architectural file 30, to obtain a ready-to-compile file 32 that includes behavioral data for simulation. A manual or automated editing process 34 may be used to obtain the file 32.

One or more embodiments of the CIDL compiler 20 also provide advantageous auto-completion features. A traditional compiler processes source code in two steps. The first step is a lexical analyzer/parser, for checking that the user has made the source code syntactically and semantically error free and complete. The second and last step is a generator (e.g. linker), for producing the target code from the parse tree which is the result of the first step. In contrast, in one or more embodiments, the CIDL compiler 20 is an auto-completing compiler that additionally performs an intermediate step that helps a user to automatically complete a system definition which is implicitly defined by the connectionless source code featured in the CIDL.

Notably, the connectionless source code model, in combination with the CIDL compiler's auto-completion processing, allows the system designer to gain maximum design reusability by expressing deterministic designs—i.e., having unambiguous implied connections—in a minimum amount of source code.

The prerequisite for auto-completion operations is that the CIDL compiler 20 is at least able to generate a complete and deterministic result from the source code. Consider a language which is used for defining a hierarchical system containing leaf components placed in hierarchical components (containers). If the hierarchical and leaf components are to be connected, the minimum connectionless source code that will give complete and deterministic connectivity is when only the leaf components have interfaces defined and when there are no ambiguities in possible interface connections.

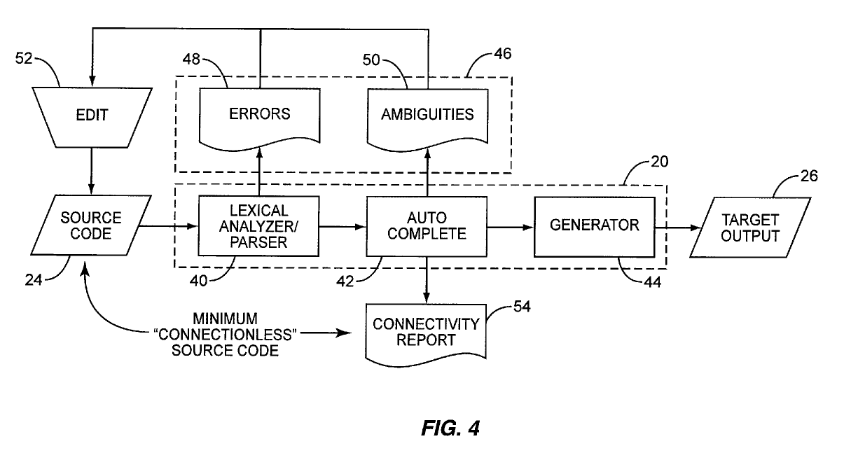

With the CIDL, interfaces are typed and it is possible to label multiple instances of the same interface type using global labels, which fulfills the requirement for non-ambiguous connectivity information. As such, FIG. 4 depicts an auto-completing version of the CIDL compiler 20, along with various input and output data items.

The CIDL compiler 20 includes a lexical parser 40, an auto-complete processor 42, and an output generator 44. In operation, the auto-complete processor 42 generates error and ambiguity information 46, which may include a connection error report 48 and/or a connection ambiguity report 50. The reported information, which preferably is human-readable output, such as an electronic text file, serves as input to an editing process 52. The editing process 52 produces corrected source code information for reprocessing by the CIDL compiler 20. Note, too, that the CIDL compiler 20 may be configured to generate a connectivity report 54. The CIDL compiler 20 may defer generation of the connectivity report until complete connectivity is achieved for the source code 24, or it may generate connectivity reports 54 even when only partial connectivity has been achieved.

One advantage of auto-completion and the CIDL's inherent use of interface types and attributes to define the appropriate connectivity between interfaces 12 that are instantiated within a given architecture 16 is that the source code 24 need not be written to include any explicit connection information. That is, the CIDL compiler 20 uses its connection rules to infer the connections that should be made between interfaces 12 within the architecture 16 represented in the source code 24. As such, the source code 24 offers a highest degree of reusability, because there are no explicit interface connections to break apart if components are moved in or removed from the architecture. CIDL source code is therefore considered “connectionless” source code, in that interface connections are implied through interface type and attribute information.

With the connectionless quality of the CIDL, new components 14 are easily added to a given architecture 16, and label or other attributes may be set as needed to resolve any connection ambiguities arising from the addition of new components 14. If a given architecture 16 is to be completely reused in a larger architecture 16, the architecture 16 being reused can be restricted—e.g., architecture “AX” implements component “CX”—to avoid having its connectivity unintentionally changed.

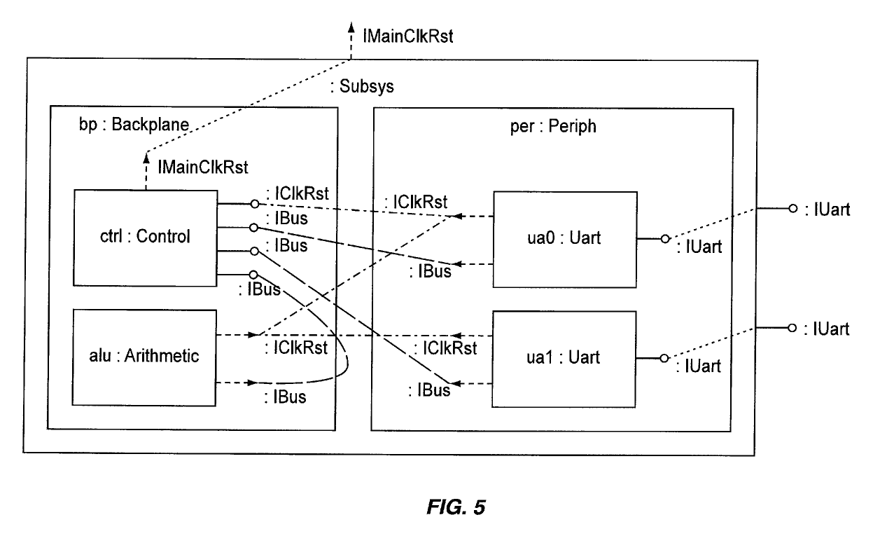

Before stepping through design reuse examples, it may be helpful to describe a CIDL-based design process without reuse. To that end, FIG. 5 illustrates a hierarchical hardware subsystem to be implemented using VHDL. The notation used is: <instance identifier>: <entity/component identifier>. In some cases, the instance name is omitted.

For further understanding of the illustration, lines in the drawing that end in circles are port connections for an interface instance that is un-mirrored, i.e., whose Mirror attribute is not set. Conversely, lines in the drawing that end in arrows are port connections for interface instances whose Mirror attribute is set. Note that bidirectional ports are the same on mirrored and un-mirrored interface instances. Further, grouped ports appear in given entity declarations, and (except for bidirectional ports which are bidirectional in both cases) the dashed lines extending between given ports represent implied connections, to be deduced or otherwise inferred by the CIDL compiler 20, based on its connection rules.

From the diagram, the VHDL entity for the UART component 14 is defined as follows:

ENTITY Uart IS

PORT (

| -- miCR interface (mirrored instance) | | |
|---|---|---|
| clk | : IN | STD_LOGIC; |
| rst | : IN | STD_LOGIC; |
| -- miBus interface (mirrored instance) | | |
| addr | : IN | STD_LOGIC_VECTOR(11 DOWNTO 0); |
| wr | : IN | STD_LOGIC; |
| wdata | : IN | STD_LOGIC_VECTOR(15 DOWNTO 0); |
| rd | : OUT | STD_LOGIC; |
| rdata | : IN | STD_LOGIC_VECTOR(15 DOWNTO 0); |
| -- iUa interface | | |
| rx | : IN | STD_LOGIC; |
| tx | : OUT | STD_LOGIC |

);

END ENTITY Uart;

If CIDL is used as the source for describing the subsystem and the contained architectures 16, components 14 and interfaces 12, all structural VHDL code can be generated by the CIDL compiler 20 (including all entity declarations, e.g. the UART entity above). Dummy architectures 16 will be generated for the leaf components (UART, Control, and Arithmetic), but no functional architectures are generated by the CIDL compiler 20, for modeling the behavior of the leaf components. The generation of behavioral instructions can be implemented manually, for example, as shown in FIG. 3. Continuing with the example of FIG. 4, the relevant interfaces 12 of the sub-system are defined in CIDL as:

```
interface IMainClkRst
{
  [out] mvl m_clk;
  [out] mvl m_rst;
}
interface IClkRst
{
  [out] mvl clk;
  [out] mvl rst;
}
interface IBus
{
  [out] mvl[11..0] addr;
  [out] mvl wr;
  [out] mvl[15..0] wdata;
  [in] mvl rd;
  [out] mvl[15..0] rdata;
}
interface IUart
{
  [in] mvl rx;
  [out] mvl tx;
}
```

The interface types may have a default attribute setting of un-mirrored, and “In” and “Out” attributes may be used in one or more embodiments of the CIDL, to define the signal directions to be associated with individual port identifiers. The “mv1” port type designation corresponds to Std_logic in VHDL, and to similar types in other HDL (Verilog/SystemVerilog etc).

Further, the leaf components are defined as:

```
component Uart
{
  [Mirror] IClkRst miCR;
  [Mirror] IBus miBus;
  IUart iUa;
}
range BLK {A, U0, U1}
component Control
{
  [Mirror] IMainClkRst miMainCR;
  [Multicast=#BLK] IClkRst iCR;
  IBus iBus[BLK];
}
component Arithmetic
{
  [Mirror] IClkRst miCR;
  [Mirror] IBus miBus;
}
```

The BLK range definition in the above CIDL source code excerpt lists a set of labels representing all component instances in the sub-system having a common interface type. As such, it guides the CIDL compiler 20 in determining how to resolve connection ambiguities. Further, the source code for the Control component instantiates the IClkRst interface type as iCR, and the Multicast attribute is set to the number of labels defined in the BLK range.

The above operations mean that iCR will be connected to several mirrored instances (one-to-many). The IBus interface type is instantiated as iBus, with an array of port labels defined in the BLK range. Each instance will have a unique label attribute attached, and these label values guide the CIDL compiler 20 when connecting mirrored interface instances (one-to-one).

Finally the architectures (containers) are defined to build the sub-system hierarchy:

```
architecture Backplane
{
  Control ctrl;
  Arithmetic alu(miBus@Label=BLK.A);
}
architecture Periph
{
  Uart ua0(miBus@Label=BLK.U0);
  Uart ua1(miBus@Label=BLK.U1);
}
architecture Subsys
{
  Backplane bp;
  Periph per;
}
```

The Backplane architecture instantiates the Arithmetic component type as alu and redefines the Label attribute for the underlying interface of type iBus. This is done in order to resolve ambiguities, i.e., to make sure this mirrored interface instance will be connected to the corresponding un-mirrored interface instantiated in the Control component. The same is valid for the Periph architecture which has two instances of the Uart component type.

According to the above source code, the CIDL compiler 20 generates the following VHDL files:

Arithmetic_e.vhd
Arithmetic_rtl_a.vhd
Backplane_e.vhd
Backplane_str_a.vhd
Control_e.vhd
Control_rtl_a.vhd
Periph_e.vhd
Periph_str_a.vhd
Subsys_e.vhd
Subsys_str_a.vhd
sys_pkg.vhd
Uart_e.vhd
Uart_rtl_a.vhd

All of the above files are used for implementing the structural architectures within the Subsys hierarchy, except for the below subset of files:

Arithmetic_rtl_a.vhd
Control_rtl_a.vhd
Uart_rtl_a.vhd

This subset of files corresponds to functional implementations of the leaf components in the design—RTL architectures—and for them the CIDL compiler 20 generates dummy implementations. The actual behavioral instructions defining these components have to be written manually, or otherwise have to be provided to a VHDL compiler, to obtain the complete VHDL implementation of Subsys.

In a design example that features design reuse, a new sub-system is implemented reusing the example implementation of FIG. 5, along with one or more third-party UART components. The source code associated with FIG. 5 is updated to reflect the new design. For example, the VHDL entity for the new UART component to be added is:

ENTITY Third_Party_Uart IS
PORT (

| | | |
|---|---|---|
| tpu_clk | : IN | STD_LOGIC; |
| tpu_rst | : IN | STD_LOGIC; |
| tpu_addr | : IN | STD_LOGIC_VECTOR(11 DOWNTO 0); |
| tpu_wr | : IN | STD_LOGIC; |
| tpu_wdata | : IN | STD_LOGIC_VECTOR(15 DOWNTO 0); |
| tpu_rd | : OUT | STD_LOGIC; |
| tpu_rdata | : IN | STD_LOGIC_VECTOR(15 DOWNTO 0); |
| tpu_rx_in | : IN | STD_LOGIC; |
| tpu_tx_in | : OUT | STD_LOGIC; |
| tpu_p1 | : IN | STD_LOGIC; |
| tpu_p2 | : OUT | STD_LOGIC; |
| tpu_p3 | : INOUT | STD_LOGIC |

);
END ENTITY Third_Party_Uart;

If the interface 12 already defined for the original UART also must be used for the third-party UART, it is possible to define a CIDL component 14 for the new UART, based on reusing the original UART interface type, without having to create a wrapper. The additional ports 10 not present on the old UART are defined in a new interface type as follows:

```
interface INotUsedUart
{
  [in] mvl p1;
  [out] mvl p2;
  [in, out] mvl p3;
}
```

The new UART component is defined as follows:

```
[SignalPrefix=“tpu_”]
component Third_Party_Uart reuses Uart
{
  redefine iUa
  {
    rx@Alias=“rx_in”,
    tx@Alias=“tx_in”
  };
  [Terminate] INotUsedUart iNUUa;
}
```

Note that the component type reuses the old UART component type, meaning that only the modified aspects need to be defined. The “redefine” clause defined by the above snippet of CIDL source code contains redefined attribute values for underlying instances (a form of attribute overriding). By using the Terminate attribute when instantiating an interface 12 containing unused ports 10, those unused ports 10 will be driven by default values (valid for in ports) or open (valid for out ports). Further, the Alias and SignalPrefix attributes are used to rename the ports 10, so the VHDL entity generated by the CIDL compiler 20 will match the one shown above.

In another example, a new peripheral architectural sub-system, named “periph2”, is added in parallel with the original periph sub-system of FIG. 5. The example architecture definition is given as:

```
architecture Periph2<component UComp>
{
  UComp ua0;
  UComp ua1;
}
```

The above Periph2 has a component type parameter to make it easier to reuse. The component type parameter is instantiated twice and the CIDL imposes no restrictions on underlying interface type instantiations. Finally a new sub-system, Subsys2, is defined as follows:

```
architecture Subsys2 extends Subsys
{
  Periph2(Third_Party_Uart) per2(ua0.miBus@Label=BLK.U2,
                ua1.miBus@Label=BLK.U3);
}
```

The new sub-system is extended from the old Subsys, which means that only additional instantiations have to be defined. Nothing from the Subsys component type can be redefined without using “reuses” instead of “extends”. To resolve the ambiguities of connections, the label range is updated to cover the new UART instances in the sub-system as such:
range BLK {A, U0, U1, U2, U3}

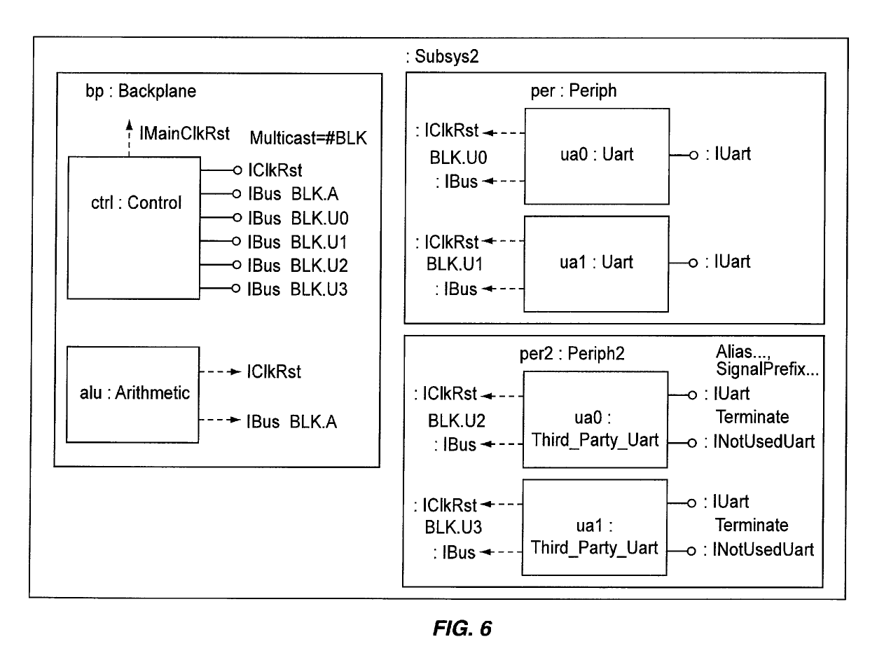

The resulting structure of Subsys2 is illustrated in FIG. 6, which does not show the connectivity explicitly, but which does map directly to the CIDL implementation. The connections are only present in the VHDL output, as they were inferred by implicit information in the CIDL source code. The block diagram depicted in FIG. 6 is annotated with attributes of different interface type instantiations, and the VHDL entity for Subsys2 is generated as follows:

ENTITY Subsys2 IS

PORT (

| -- bp_ctrl_miMainCR interface | | |
|---|---|---|
| m_clk | : IN | STD_LOGIC; |
| m_rst | : IN | STD_LOGIC; |
| -- per_ua0_iUa interface | | |
| per_ua0_iUa_rx | : IN | STD_LOGIC; |
| per_ua0_iUa_tx | : OUT | STD_LOGIC; |
| -- per_ua1_iUa interface | | |
| per_ua1_iUa_rx | : IN | STD_LOGIC; |
| per_ua1_iUa_tx | : OUT | STD_LOGIC; |
| -- per2_ua0_iUa interface | | |
| tpu_per2_ua0_iUa_rx_in | : IN | STD_LOGIC; |
| tpu_per2_ua0_iUa_tx_in | : OUT | STD_LOGIC; |
| -- per2_ua1_iUa interface | | |
| tpu_per2_ua1_iUa_rx_in | : IN | STD_LOGIC; |
| tpu_per2_ua1_iUa_tx_in | : OUT | STD_LOGIC |

);

END ENTITY Subsys2;

Notably, only the ports 10 of unconnected or non-terminated interfaces 12 exist within the entity.

Thus, in one or more embodiments, for an extend instruction in the source code 24 that names a new entity as an extended copy of a defined entity, the auto-complete method disclosed herein automatically generates component interface connections for the new entity, including component interface connections for component interfaces copied from the defined entity and any component interface connections added in association with the extend instruction. As shown in the above example, an “entity” may be a component 14 or architecture 16 represented in the source code 24.

With the above practical instantiation examples in mind, additional CIDL details may be helpful. Regarding interfaces 12 and their (inter) connections, there are different levels of abstractions for given interface types. At one level of abstraction, CIDL works with groups of ports for Register Transfer Level (RTL) modeling. Further, in CIDL only one “side” of an interface 12 needs to be defined as mirrored or un-mirrored, which are akin to master/slave designations. If the mirroring attribute is not set (Mirror=False), the interface 12 is considered to be a “master.” Conversely, if the mirroring attribute is set (Mirror=True), the interface 12 is considered to be a “slave.” As the mirror attributes are complementary, the CIDL compiler 20 automatically evaluates mirrored and un-mirrored “sides” of interfaces 12 that are of like types.

An example of an RTL interface in CIDL is as follows:

| | |
|---|---|
| | //Attribute specifying “the one side” |
| interface IAA | //Interface type declaration |
| { | |
| [Out] a; | //Port instantiation. The port type |
| [In] b1; | //is “MVL” by default (corresponds to |

| | |
|---|---|
| [In] b2; | //“Std_ulogic” in VHDL) |
| [Out] start_a; | |
| [In] start_b1; | |
| [In] start_b2; | |
| } | |

In this case, the “IAA” interface instantiates a number of ports 10 of the type “MVL” (Multi Valued Logic) by default, which corresponds to “Std_ulogic” in VHDL. It is also possible to use other types for ports 10, e.g. integer, boolean, struct etc. (as in done in the established HDL languages).

At another level of abstraction, one or more embodiments of the CIDL provided for an “Abstract” interface attribute, which is used to generate a template in, e.g., System Verilog. It is therefore possible to automatically generate mixed language/abstraction interface interconnections of different abstraction levels, e.g., a transaction level model in System Verilog.

Further, it is possible in CIDL to define a hierarchical system of components 14, where only leaf components have interfaces instantiated. There is no need to connect these interfaces explicitly, as the CIDL compiler 20 will try to connect interface instances of different “sides” automatically, using the mirrored/un-mirrored attributes. If multiple instances of the same interface 12 are conflicting, the Label attribute can be assigned a value of a range type (global enumerated type). Label attribute values enable the CIDL compiler 20 to reconcile connection ambiguities among interfaces 12. Also, label attributes can be redefined (using another range type) on higher hierarchy levels in order to resolve connection conflicts.

It is possible to define one interface type supporting both abstraction levels. In this case the body of the transaction function needs to be defined within the interface. If instances of the same interface type but different abstraction levels are connected, conversion functionality will be generated automatically. It is also possible to manually connect ports within different interface types. In extended mode of CIDL the ports of different interface type could be labeled which would support automatic connection.

Turning to leaf components, a leaf component is defined by the component type, where it is possible to instantiate interface and register types. A leaf component does not have any architecture associated with it, nor is any functionality described, because the CIDL is used for describing interface connections, not functional behavior. An example leaf component instantiation is as follows:

```
component CA //Component type declaration
{
  [Mirror] IAA piaa; //Interface instantiation
  IAB riab;
  register
  {
    FColor color;
  } ctrl; //Register instantiation
}
```

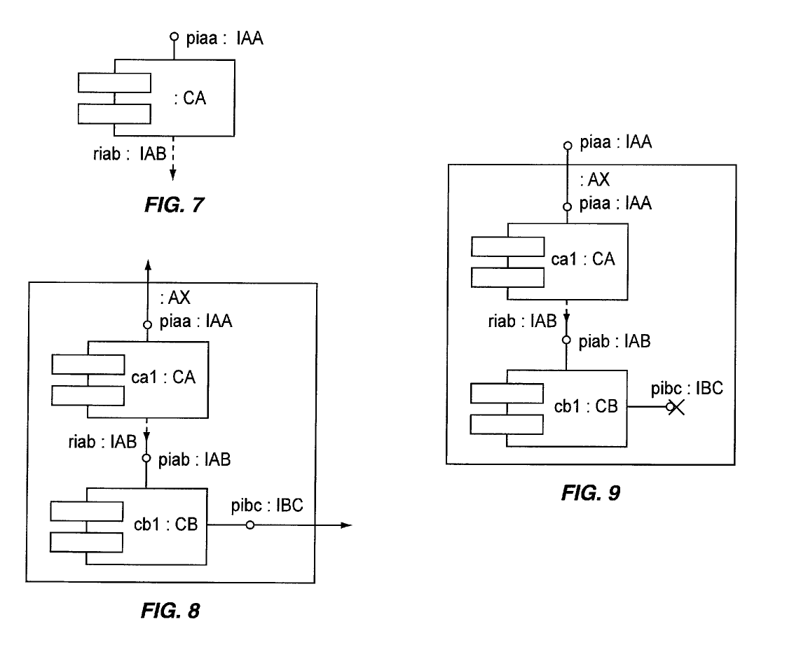

FIG. 7 illustrates a symbolic representation of the above-instantiated leaf component. (Note that un-mirrored interfaces also may be referred to as “requires” interfaces, and FIG. 7 and several other figures adopt a naming convention wherein the prefix “r” is included in the interface name. Similarly, “mirrored” also may be referred to as “provides,” and FIG. 7 and others use a “p” prefix in the names of mirrored interfaces.)

Fields of register instances in a component 14 may be connected to ports 10 of interface instances via conditional statements. The CIDL compiler 20 is correspondingly able to generate control logic and multiplexers (e.g. for test purposes). Further, different kinds of relations between fields and ports can be defined, for example, such as where they have attributes dedicated to interrupt functionality.

The CIDL further defines “composite” components. A composite component (hierarchical architecture) is defined by the architecture type and, optionally, it implements the component type. In an architecture type definition, it is possible to instantiate other component types (composites or leafs), and it is also possible to instantiate multiple instances of the same type.

As a further feature of the CIDL, when an architecture type is said to implement a component type, it will be restricted to the interfaces defined by the component, as previously explained. A restricted architecture fulfills a “contract” and only the interface instances of the component will exist at the boundary of the architecture. However, as long as architectures are not restricted, it is possible to use a pure bottom-up design methodology. That is, for an unrestricted architecture 16, interfaces that will not be connected or terminated internally in a given architecture 16 by the CIDL compiler 20 will be propagated out of the architecture's boundary. The CIDL compiler 20 also can generate “matching” component types, containing instances of the propagated interfaces. These component types thus can be used to “restrict” the connections made to/from a given architecture 16.

Thus, a given architecture 16 may implement a predefined component type in order to constrain what interfaces can be propagated out of the architecture type by the CIDL compiler 20 (top-down), or the designer may trust that the subsystems within the architecture 16 are defined properly, such that CIDL complier 20 will be able to correctly propagate their interfaces upward in the architecture's hierarchy as part of the CIDL compiler's automatic interconnection processing (bottom-up). Having the possibility to choose between these different design methodologies allows a designer using the CIDL to balance between design effort and confidence.

FIG. 8 depicts an example of an unrestricted architecture 16, according to the below CIDL source code excerpt:

```
architecture AX
{
  CA ca1;
  CB cb1;
}
```

When the CIDL compiler 20 connects matching interfaces 12 and promotes remaining interfaces 12 out of a given architecture 16, it is possible to generate matching component types. A matching component type example is as follows:

```
component CX  //Post-generated component type
{
  [Mirror] IAA piaa;
  [Mirror] IBC pibc;
}
```

Conversely, an example of restricted architecture 16, using the CIDL keyword “implements,” is shown in FIG. 9 and represented in CIDL source code as follows:

```
component CX  //Predefined component type
{
  [Mirror]IAA piaa;
}
architecture AX
implements CX
{
  CA ca1;
  CB cb1;
}
```

When the CIDL compiler 20 connects matching interfaces 12 and promotes remaining interfaces 12 out of the above-represented architecture 16, it will be constrained by the restricted component type. Thus, the CIDL compiler 20 reports that the “pibc” interface instance needs to be taken care of, such as by termination or by instantiating a new component type including a matching interface instance. Such information can be output by the CIDL compiler 20 in human-readable form, such as in a connectivity and/or ambiguity report.

As a further feature of the CIDL, “types” of interfaces, components, and/or architectures can be parameterized, and parameterized types can be used for creating system design templates. For example, an architecture template may have a component type and an integer constant as parameters. Another parameterized component type would thus be instantiated within the architecture using the integer constant. A corresponding CIDL source code excerpt example is as follows:

```
component CC<ARR_SIZE>
{
  ...
}
architecture AY<component COMP, int ARR_SIZE>
{
  CA ca1;
  COMP comp;
  CC<ARR_SIZE> cc1;
}
```

The general parameterization of types in the CIDL is a new feature for languages used in structural hardware design. For example, in the CIDL it is possible to pass any component 14 as parameter (having any types of interfaces 12 instantiated within it). Thus, in one embodiment, the CIDL compiler 20 instantiates an architecture 16 within a hierarchical architecture defined by the source code 24, according to a parameters list identifying one or more preexisting component types to implement within the architecture. This parametric polymorphism means that the particular component interface connections generated by the CIDL compiler 20 depend on the particular values set for the parameterized type information in the source code 24, meaning that new or different connections can be generated from the same source code, simply by updating the parameter values.

In addition to allowing parameterized templates as above, at least one embodiment of the CIDL (and the associated CIDL compiler 20) allow for “reuse” templates. In such embodiments, some or all of the defined types within the CIDL can be reused. With reuse, a given architecture 16 can be reused as a starting template for a new design, simply by setting a used/unused attribute for individual entities or groups of entities included within the architecture 16—here, an entity is any type of entity defined in the CIDL, such as an interface 12, a component 14, or an architecture 16. Entities marked as unused are not included in the reused design. Further, the designer can add new architectures and components to a reused design, as needed.

A source code example of a reused architecture type is as follows:

```
architecture AXPrim<int ARR_SIZE>
implements CX
reuses AX
{
  cb1@Unused = True;
  CC<ARR_SIZE> cc1;
}
```

The “cb1” component instance in the above source code snippet is assigned the attribute “Unused,” and the CIDL compiler 20 thus will disregard this component instance during compilation—i.e., the cb1 component will not be instantiated as part of instantiating the new architecture AXPrim. However, the “cc1” component instance is a new instance of a previously defined “CC” component type, and it will be instantiated.

It is also possible to reuse architecture types and add component instances on any level in the design hierarchy by using “.” notation. The following source code provides a good hierarchical architecture example:

```
architecture AU
{
  architecture
  {
    AX ax1;
    ...
  } av1;
}
```

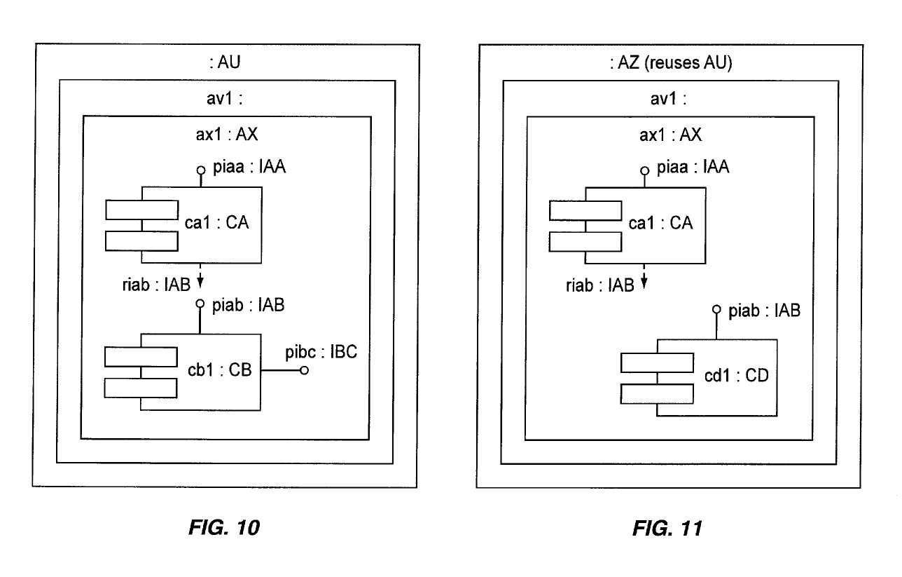

FIG. 10 illustrates the above-described architecture, wherein the “AX” architecture type is instantiated in an architecture instance called “av1”, which, in turn, in instantiated in “AU”.

A source code example of a reused hierarchical architecture type is as follows:

```
component CD
{
  [Mirror] IAB piab;
}
architecture AZ
reuses AU
{
  av1.ax1
  {
    cb1@Unused = True
    CD cd1;
  }
}
```

FIG. 11 illustrates the above-coded reuse example, where “AZ” reuses “AU”, but the “cb1” will be disregarded by the CIDL compiler 20. Further, the CIDL compiler 20 will instantiate a new component “cd1” in the underlying “ax1” instance of the “AX” architecture type.

Further, one or more embodiments of the CIDL and the CIDL compiler 20 provide for a “Remove” construct, which can serve as an alternative to the “used/unused” attribute. For example,

```
architecture Ax
{
  CB b;
  CC c;
}
architecture Ay reuses Ax
{
  Remove (c);
  CD d;
}
```

The architecture Ay will contain the “b” and “d” instances of types “CB” and “CD”, respectively. The “Remove” attribute also works hierarchically; that is, it is possible to remove instances multiple levels down in an architectural hierarchy.

Modifying an architecture 16 several levels down in its hierarchy is sometimes convenient, but it will be impossible to reuse the actual instance because it is not consistent with the type definition any longer. To enable such reuse, the lower-level architecture type needs to be updated explicitly. The CIDL compiler 20 is configured to support this task, i.e. it generates reusable types from modified architecture instances, which can be regarded as re-factoring the CIDL source code. The CIDL compiler 20 takes into account the order in which architecture types have been reused, and it optionally generates parameterized architecture types for the hierarchy.

As another point of power and convenience, the CIDL and the associated CIDL compiler 20 support labeling and the redefinition of attributes. Consider the problem of having multiple instances of interfaces 12 to connect in a given system design represented by an architecture 16. The below excerpt of CIDL source code provides such an example of a common interrupt request interface type, as provided by one instance of an interrupt controller (IC) component 14, for multiple instances of a UART component 14:

```
interface IIrq
{
    [In] irq;
  ...
}
```

The UART component type is as follows:

```
component CUart
{
  IIrq riirq;
  ...
}
```

Assume the CUART and an architecture type containing two instances of this component were created in advance. To avoid conflicts when the CIDL compiler 20 is connecting to the interfaces of the UARTs, a range type was defined and mapped to label attributes of the interface instances, as follows:

```
range PeripheralsRange
{
  UART1, UART2
}
architecture APeripherals
{
  CUart uart[0..1]@Label =
    PeripheralsRange(UART1..UART2);
}
```

If the IC is designed for connecting four UART's, a corresponding range type needs to be created and labels of the interface instances can be mapped to this range type, when defining the component. An example source code excerpt is as follows:

```
range AllPeripheralsRange
{
  UART1, UART2, UART3, UART4
}
component CIC
{
  [Mirror] IIrq piirq[0..3]@Label =
    AllPeripheralsRange(UART1..UART4);
  ...
}
```

Else, if the IC is a generic design that does not care about how many and in which order interfaces are connected, it can be defined as below, using an unconstrained array of interface instances. In this case the CIDL compiler 20 will determine the size of the array, when connecting interfaces of the same type (having the mirrored attribute attached):

```
component CIC
{
  IIrq pirq[ ];
  ...
}
```

Finally, the complete system is created by instantiating the CIC component and two APeripherals architectures. The “Label” attributes of the underlying CUART interfaces must be redefined in order to avoid conflicts when the CIDL compiler 20 is connecting the interfaces as follows:

```
architecture ASystem
{
  CIC ic;
  APeripherals p[0..1];
  p[0..1].uart[0..1]@Label = AllPeripheralsRange;
}
```

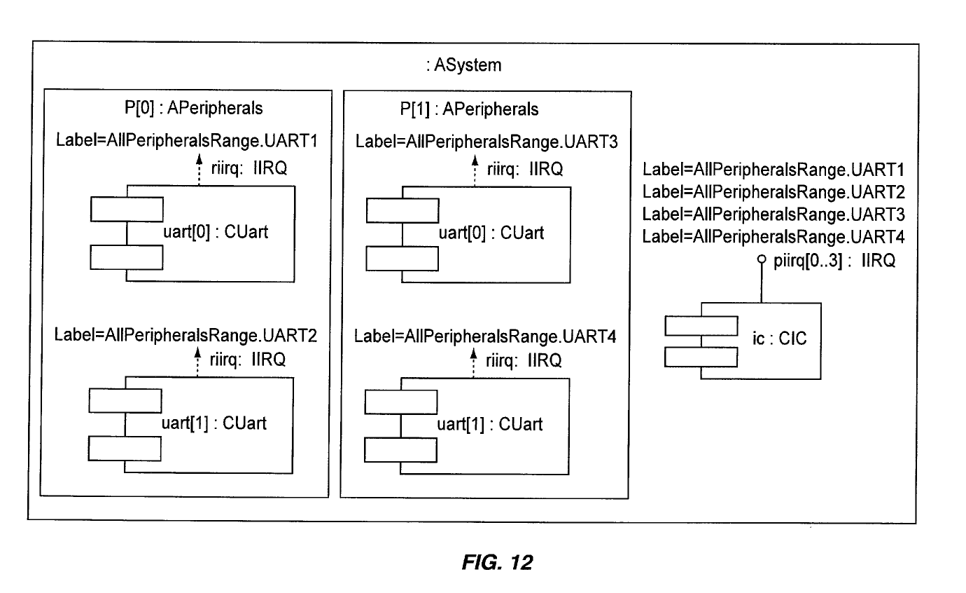

FIG. 12 illustrates “ASystem” as structured by the CIDL compiler 20 according to the above source code excerpts.

The CIDL and the CIDL compiler 20 offer further flexibility through the use of “cables” and “interface maps.” Regarding these features, it is common in hardware (RTL) design that individual signals defined in a HDL are shared between blocks and connected to different ports. If interface types have already been defined in CIDL with the aim to be reused, it is possible that there will be ports that appear in more than one interface type and consequently need to be connected. The cable construct in CIDL allows the designer to specify individual port connections between different interface types.

In turn, the CIDL compiler 20 provides auto-connection between cabled ports, even though the connection passes between respective ports 10 in different types of interfaces 12. In this case there are no restrictions on what “side” the interface instances belong because they are of different types. In one or more embodiments, the CIDL compiler 20 checks that the port directions match.

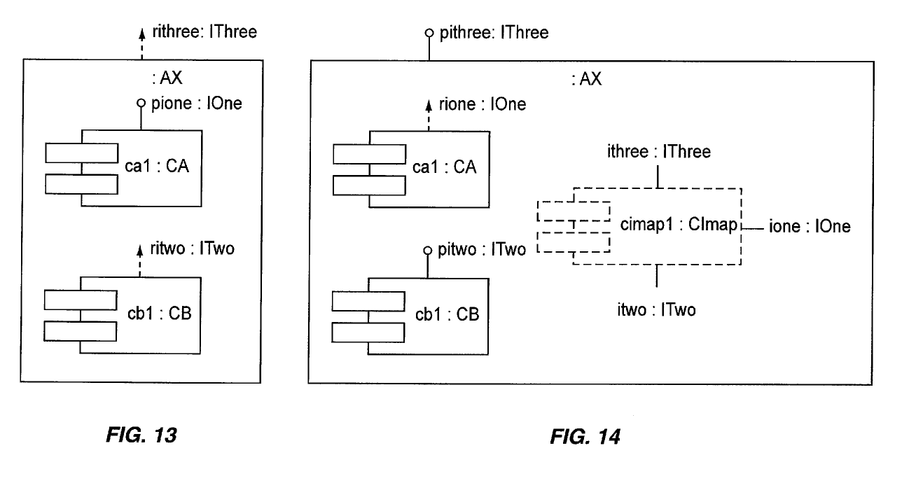

As an example, FIG. 13 depicts two components, “ca1” of type “CA” and “cb1” of type CB, where there are no matching instances that would be automatically connected by the CIDL compiler 20 through application of its “standard” set of hierarchical connection rules 22. However, an example of CIDL source code where the interface ports are defined is as follows:

```
interface IOne
{
  [In] s1;
  [Out] s2;
}
interface ITwo
{
  [In] s1;
  [In] s2;
  [Out] s3;
}
interface IThree
{
  [In] s1;
  [Out] s3;
}
component CA
{
  [Mirror] IOne pione;
}
component CB
{
  ITwo ritwo;
}
component CX
{
  IThree rithree;
}
architecture AX implements CX
{
  CA ca1;
  CB cb1;
  cable
  {
    (rithree.s1),
    (ca1.pione.s1),
    (cb1.ritwo.s1)
  } s1;
  cable
  {
    (rithree.s3),
    (cb1.ritwo.s3)
  } s3;
    cable
    {
      (ca1.pione.s2),
      (cb1.ritwo.s2)
  } s2;
}
```

In the above CIDL source code excerpts, the individual ports of the different interfaces are connected explicitly by the cable construct. Cable “s1” is defined first and it is connected the “s1” port of the “rithree” instance of the CX component type (implemented by the AX architecture type). Cable “s1” is also connected to the “s1” ports of the “pione” and “ritwo” instances of the “ca1” and “cb1” instances respectively.

One or more embodiments of the CIDL and the CIDL compiler 20 provide a further solution to the problem of having to connect ports of different interface types. Namely, the CIDL allows the designer to create a component type that operates as a “map” or “converter” between different types of interfaces 12. One might use a mapping component if the conversion is more complex than can be conveniently solved by embedding cable constructs within interface instances, as described above, or if the interconnection problem should be solved in a more general way than is provided for with cabling within the interface types that will be actually instantiated within a given design.

Mapping components are “virtual,” meaning that they are not instantiated in the design output—e.g., the CIDL output 26 of FIG. 1—and instead are used to provide the CIDL compiler 20 with a package of cabling constructs that specify interface port connections between different types of interfaces 12 within a given architecture 16. The CIDL and the CIDL compiler 20 thus support a “Virtual” attribute for components. If the attribute “Virtual” is attached to a component 14, no corresponding component instance will exist in the generated HDL code; only the connections defined by the cable constructs carried within the virtual component will be generated. Hence, virtual components act as mapping components.

It is also possible to cause the CIDL compiler 20 to generate multiplexer logic, by adding conditional logic statements within given cable constructs. FIG. 14 illustrates an example of using a component as an interface map, and the corresponding CIDL definition of the interface map component is given as:

```
component CImap
{
  IOne ione;
  ITwo itwo;
  IThree ithree;
  cable
  {
    if s2==0
    {(ithree.s1), (ione.s1)}
    else
    {(ithree.s1), (itwo.s1)}
  } s1;
  cable
  {
    (ithree.s3),
    (itwo.s3)
  } s3;
  cable
  {
    (ca1.pione.s2),
    (cb1.ritwo.s2)
  } s2;
}
```

In the above case, the CIDL compiler 20 will generate a multiplexer from the conditional cable construct, where the control signal “s2” is driven from the “cb1” instance (“pitwo” interface). The remaining input signals are “ione.s1” and “itwo.s1” and the output signal is “ithree.s1”.

For conditional cable constructs, depending on the direction of the interface ports and certain interface attributes, the CIDL compiler 20 will generate multiplexer and/or de-multiplexer or direct (bus) connections. If cables are used extensively to connect ports of different interface types, a better option would be to use an extended mode of the CIDL, where ports could be labeled. With port labeling, the CIDL compiler 20 can use an extension of its connection rules 22, wherein it interconnects ports 10 based on matching port label attribute values, in much the same way that labeling can be used to implicitly indicate connections between different interfaces 12. At least one embodiment of the CIDL compiler 20 supports port labeling, and, advantageously, at least one such embodiment prioritizes connections between interface instances, before connecting individual ports 10 of different types.

Of course, the present invention is not limited to the foregoing discussion examples, or to the examples depicted in the accompanying drawings. Instead, the present invention is limited only by following appended claims, and to their legal equivalents.

What is claimed is:

1. A method of automatically generating component interface connections for components represented in source code defining a hierarchical architecture of components, said method comprising processing the source code via a programmed computer system, including:
parsing the source code according to a defined set of connection rules, including a first connection rule that automatically makes one-to-one connections between signal ports included in unambiguous pairings of complementary component interfaces of the same type, and a second connection rule that automatically makes one-to-many connections between signal ports included in unambiguous groupings of complementary component interfaces of the same type; and
outputting component interconnection data as computer-readable electronic data that specifies the automatically generated component interface connections, for subsequent modeling of the hierarchical architecture of components in a targeted implementation language or simulation environment.

2. The method of claim 1, wherein parsing the source code according to the first and second connection rules includes traversing the hierarchical architecture to identify the unambiguous pairings and groupings of complementary component interfaces of the same type, within and across all hierarchical levels of the hierarchical architecture, except for component interfaces that are restricted to their corresponding hierarchical levels.

3. The method of claim 1, wherein parsing the source code according to the first connection rule comprises connecting corresponding signal ports included in any two component interfaces of the same type, if one of the two component interfaces is un-mirrored and the other is mirrored, and if those two component interfaces are the only instances of that interface type within the hierarchical architecture.

4. The method of claim 3, wherein parsing the source code according to the second connection rule comprises connecting corresponding signal ports among more than two component interfaces of the same type, if one of the more than two component interfaces is un-mirrored and the others are mirrored, and if the un-mirrored component interface has a multicast attribute set to a value greater than one.

5. The method of claim 4, further comprising parsing the source code according to a third connection rule that connects corresponding signal ports between two component interfaces of the same type, if one of them is un-mirrored and the other is mirrored, and if they have label attribute values that are the same.

6. The method of claim 5, further comprising parsing the source code according to a fourth connection rule that propagates any given component interface out of its architectural level within the hierarchical architecture for interconnection with another component interface of the same type at a different architectural level, if application of the first through third connection rules does not result in connecting the given component interface within its architectural level, or if the value of a multicast attribute of the given component interface exceeds the number of found one-to-many connections for the given component interface at its architecture level.

7. The method of claim 1, further comprising parsing the source code according to a first additional connection rule that performs bottom-up hierarchical connections combined with interface propagation, wherein signal ports for given component interfaces are propagated from their given architectural levels, as needed, to obtain complete connectivity for all component interfaces within an overall system hierarchy that is defined by or includes the hierarchical architecture.

8. The method of claim 7, further comprising parsing the source code according to a second additional connection rule that inhibits interface propagation for component interfaces that are within a restricted level of the hierarchical architecture.

9. The method of claim 7, further comprising parsing the source code according to a second additional connection rule that inhibits interface propagation for any given component interface that has a terminate attribute set, and further comprising driving signal port lines of component interfaces having set terminate attributes with default or user-configured signal values.

10. The method of claim 1, further comprising instantiating a component interface, a component, or an architecture, within the hierarchical architecture by extending or reusing a preexisting component interface type, a preexisting component type, or a preexisting architecture type.

11. The method of claim 10, further comprising instantiating an architecture within the hierarchical architecture according to a parameters list identifying one or more preexisting component types to implement within the architecture.

12. The method of claim 10, further comprising overriding an attribute value or replacing a type instance of the preexisting interface type, the preexisting component type, or the preexisting architecture type, as part of instantiating the component interface, the component, or the architecture.

13. The method of claim 1, wherein, for an extend instruction in the source code that names a new entity as an extended copy of a defined entity, automatically generating component interface connections for the new entity, including component interface connections for component interfaces copied from the defined entity and any component interface connections added in association with the extend instruction.

14. A computer system configured to automatically generate component interface connections for components represented in source code defining a hierarchical architecture of components, said computer system comprising:
memory to hold the source code for processing; and
a processor configured to:
parse the source code according to a defined set of connection rules, including a first connection rule that automatically makes one-to-one connections between signal ports included in unambiguous pairings of complementary component interfaces of the same type, and a second connection rule that automatically makes one-to-many connections between signal ports included in unambiguous groupings of complementary component interfaces of the same type; and
output component interconnection data as computer-readable electronic data that specifies the automatically generated component interface connections, for subsequent modeling of the hierarchical architecture of components in a targeted implementation language or simulation environment.

15. The computer system of claim 14, wherein the processor is configured to parse the source code according to the first and second connection rules by traversing the hierarchical architecture to identify the unambiguous pairings and groupings of complementary component interfaces of the same type, within and across all hierarchical levels of the hierarchical architecture, except for component interfaces that are restricted to their corresponding hierarchical levels.

16. The computer system of claim 14, wherein, according to the first connection rule, the processor is configured to connect corresponding signal ports included in any two component interfaces of the same type, if one of the two component interfaces is un-mirrored and the other is mirrored, and if those two component interfaces are the only instances of that interface type within the hierarchical architecture.

17. The computer system of claim 16, wherein, according to the second connection rule, the processor is configured to connect corresponding signal ports among more than two component interfaces of the same type, if one of the more than two component interfaces is un-mirrored and the others are mirrored, and if the un-mirrored component interface has a multicast attribute set to a value greater than one.

18. The computer system of claim 17, wherein the processor is further configured to parse the source code according to a third connection rule, wherein the processor is configured to connect corresponding signal ports between two component interfaces of the same type, if one of the two component interfaces is un-mirrored and the other is mirrored, and if the two component interfaces have label attribute values that are the same.

19. The computer system of claim 18, wherein the processor is further configured to parse the source code according to a fourth connection rule, wherein the processor is configured to propagate any given component interface out of its architectural level within the hierarchical architecture, for interconnection with another component interface of the same type at another architectural level, if application of the first through third connection rules does not result in connecting the given component interface within its architectural level, or if the value of a multicast attribute of the given component interface exceeds the number of found one-to-many connections for the given component interface at its architecture level.

20. The computer system of claim 14, wherein the processor is further configured to parse the source code according to a first additional connection rule, wherein the processor is configured to make bottom-up hierarchical connections in combination with component interface propagation, wherein signal ports for given component interfaces are propagated out from their given architectural levels, as needed, to obtain complete connectivity for all component interfaces within an overall system hierarchy that is defined by or includes the hierarchical architecture.

21. The computer system of claim 20, wherein the processor is configured to parse the source code according to a second additional connection rule, wherein the processor inhibits interface propagation for component interfaces that are within a restricted level of the hierarchical architecture.

22. The computer system of claim 20, wherein the processor is further configured to parse the source code according to a second additional connection rule, wherein the processor is configured to inhibit interface propagation for any given component interface that has a terminate attribute set, and is configured to drive signal port lines of component interfaces having set terminate attributes with default or user-configured signal values.

23. The computer system of claim 14, wherein the processor is further configured to instantiate a component interface, a component, or an architecture, within the hierarchical architecture by extending or reusing a preexisting component interface type, a preexisting component, or a preexisting architecture.

24. The computer system of claim 23, wherein the processor is further configured to instantiate an architecture within the hierarchical architecture according to a parameters list identifying one or more preexisting component types to implement within the architecture.

25. The computer system of claim 23, wherein the processor is further configured to override or replace a type instance of the preexisting interface type, the preexisting component, or the preexisting architecture, as part of instantiating the component interface, the component, or the architecture.

26. The computer system of claim 14, wherein, for an extend instruction in the source code that names a new entity as an extended copy of a defined entity, the processor is configured to automatically generate component interface connections for the new entity, including component interface connections for component interfaces copied from the defined entity and any component interface connections added in association with the extend instruction.
